(19) United States
(12) Patent Application Publication
(10) Pub. No.: US 2020/0223754 A1
(43) Pub. Date: Jul. 16, 2020

(54) POLYDICARBOXYLIC ACID BASED DISPERSANT

(71) Applicant: SIKA TECHNOLOGY AG, Baar (CH)

(72) Inventors: Yalei CHEN, Suzhou (CN); Christina HAMPEL, Ruetihof (CH); Jianghong LIU, Suzhou (CN); Joerg ZIMMERMANN, Winterthur (CH)

(73) Assignee: SIKA TECHNOLOGY AG, Baar (CH)

(21) Appl. No.: 16/611,132

(22) PCT Filed: Jul. 27, 2017
(86) PCT No.: PCT/CN2017/094758

§ 371 Date: Nov. 5, 2019

(51) Int. Cl. C04B 24/26; C08F 293/00; C04B 28/04; C04B 28/14

(52) U.S. Cl. CPC C04B 24/2694; C08F 293/00; C04B 2103/408; C04B 28/14; C08F 2438/03; C04B 28/04

(57) ABSTRACT

A copolymer, in particular a dispersant for hydraulically setting binder compositions, including a specific dicarboxylic acid based subunit and a specific polyalkylene glycol based subunit wherein the molar ratio of the dicarboxylic acid based subunit to the polyalkylene glycol based subunit is from 1.5-4.

### TECHNICAL FIELD

The invention relates to a copolymer, in particular a dispersant for hydraulically setting binder compositions, and its use as well as a method for producing such kind of copolymers. Further aspects of the invention are related to hydraulically setting binder compositions and moldings obtainable from binder compositions.

### BACKGROUND ART

Dispersants are used as plasticizers or water-reducing agents for hydraulically setting binder compositions, such as concrete, mortars, cements, plasters, and lime, for example. The dispersants are generally organic polymers, which are added to the mixing water or admixed in solid form to the binder compositions. As a result, it is possible to advantageously modify not only the binder composition consistency during processing but also the properties in the cured state.

In this regard, US 2015/0152007 A1 (Nippon Shokubai Co. Ldt.) describes for example dispersants based on polycarboxylic acid copolymers. The copolymers include a structural unit derived from an unsaturated polyalkylene glycol ether monomer with a predetermined structure and a structural unit derived from an unsaturated carboxylic acid monomer. The unsaturated polyalkylene glycol ether monomer can e.g. comprise an alkenyl group such as a vinyl group, an allyl group, a methallyl group, and a 3-methyl-3-butenyl group. Inter alia, the unsaturated carboxylic acid monomer can be selected from unsaturated dicarboxylic acid monomers such as e.g. maleic acid, fumaric acid, and itaconic acid. The copolymers can be produced by solvent or bulk copolymerization with a polymerization initiator. Typically, the copolymerization is effected at temperatures of around 60° or more comprising mercaptopropionic acid as a chain transfer agent.

Also US 2014/0051801 A1 (Sika Technology AG) describes polymers of maleic acid, allyl ether and (meth)acrylic acid compounds. Thereby, the polymers are produced by free radical polymerisation at temperatures of 10 to 500.

However, a particular problem with known dispersants consists of the facts that (i) some of the dispersants are not as effective as desired, (ii) that the long-term processability of mineral binder compositions decreases rapidly over time, so that after only a short time the hydraulically setting binder compositions are only poorly processable, (iii) that costly processes are required to produce the dispersants and/or (iv) that the dispersants are only efficient in combination with in certain selected binder compositions.

There is thus a need to develop new and improved dispersants which reduce or overcome the aforementioned drawbacks.

### DISCLOSURE OF THE INVENTION

It is an object of the present invention to provide methods and dispersants which do not have the above mentioned drawbacks. In particular, new dispersants with improved properties for use in mineral binder compositions shall be supplied. The dispersants are said to display an improved and as long lasting plasticizing effect in mineral binder compositions as possible. Also, the dispersants shall be obtainable in a technically as simple manner and as economically as possible. Moreover, new methods shall be provided which allow for producing such kind of dispersants.

Surprisingly, it has been found that the problem of the invention can be solved by a copolymer according to claim 1.

It has been found that with such kind of copolymers it is possible to obtain improved and as long lasting plasticizing effects in mineral binder compositions. This even in various and different mineral binder compositions such as in cement as well as in gypsum based compositions. Thus the inventive copolymers can be used in a flexible manner as a dispersing agent in combination with different mineral binders.

Also it is possible to produce the inventive copolymers in a relatively simple polymerization process even at temperatures as low as 10°.

Moreover, the copolymers provided in accordance with the invention are highly compatible with other additives, such as with further dispersants, for example.

Further aspects of the invention are subjects of further independent claims. Particularly preferred embodiments of the invention are subjects of dependent claims.

### WAYS OF CARRYING OUT THE INVENTION

A first aspect of the invention relates to a copolymer, in particular a dispersant for mineral binder compositions, comprising or consisting of:

a) a mole fractions of a structural subunit S1 of the formula (I)

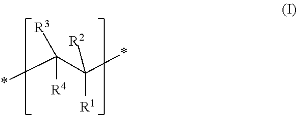

b) b mole fractions of a structural subunit S2 of the formula (II)

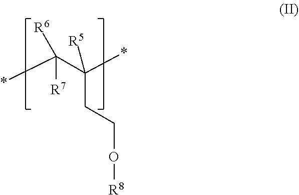

c) optionally, c mole fractions of a further structural subunit S3;
where
R¹ and R⁴, in each case independently of any other, is —COOM, —(CH₂)—COOM, COOR⁸, in particular —COOM, or R¹ and R⁴ together form an anhydride group —(CO)—O—(CO)—;
R², R³, R⁶, and R⁷, in each case independently of one another, are H or an alkyl group with 1-5 carbon atoms, in particular H;
R⁵, in each case independently of one another, is an alkyl group with 1-5 carbon atoms, in particular a methyl group;
R⁸, in each case independently of one another, is a group of the formula -[AO]ₙ—R^{a}, where
   A is C₂— to C₄-alkylene,
   R^{a} is H, a C₁ to C₂₀ alkyl, cycloalkyl or alkylaryl group, and
   n is 2-250, in particular n is 10-120;
M, independently of any other, is H⁺, an alkali metal ion, an alkaline earth metal ion, a di- or trivalent metal ion, an ammonium ion or an organic ammonium group
and where a, b, and c are mole fractions of the respective structural subunits S1, S2, an S3, where
a/b/c=(0.1-0.9)/(0.1-0.9)/(0-0.8), more particularly
a/b/c=(0.4-0.85)/(0.15-0.5)/(0-0.6), preferably
a/b/c=(0.6-0.8)/(0.2-0.4)/(0-0.01), and
with the proviso that a+b+c is 1;
and where a ratio of the mole fractions a/b is 1.5-4.

The sequence of the structural subunits S1, S2, and S3 may be alternating, block-like or random. It is also possible, moreover, for there to be further structural subunits in addition to the structural subunits S1, S2, and S3.

The structural subunits S1, S2, an S3 together preferably have a weight fraction of at least 50 wt %, more particularly at least 90 wt %, very preferably at least 95 wt % or at least 99 wt %, of the total weight of the copolymer. Even more preferred, the structural subunits S1 and S2 together have a weight fraction of at least 50 wt %, more particularly at least 90 wt %, very preferably at least 95 wt % or even 99 wt. %, of the total weight of the copolymer.

Especially preferred are copolymers with R²═R³═H and wherein R¹═R⁴=—COOM and/or wherein R¹ and R⁴ together form an anhydride group —(CO)—O—(CO)—. Such kind of copolymers can be produced starting from maleic acid and/or maleic acid anhydride. Besides technical advantages associated with such kind of copolymers, this being also of advantage from an economic standpoint.

With regard to structural subunit S2, R⁵ is preferably a methyl group and R⁶=R⁷═H. Advantageously R⁵ is a methyl group. Copolymers of these kinds can be prepared, for example, starting from isoprenol alcohols or isoprenol ethers.

Preferably, a proportion of ethylene oxide units or C₂-alkylene oxide units in the group of the formula -[AO]ₙ—R^{a}, based on all the alkylene oxide or C₂-alkylene oxide units present in the group of the formula -[AO]ₙ—R^{a}, is more than 90 mol %, especially more than 95 mol %, preferably more than 98 mol %, in a particular 100 mol %. This is in particular advantageous if air entrainment by the copolymers shall be reduced. However for special applications, copolymers comprising higher proportions of C₃— and or C₄-alkylene oxide units in the groups of the formula -[AO]ₙ—R^{a} might be suitable as well.

Also, with highly preferred copolymers, n is 10-120, especially 22-80, preferably 30-70, especially preferred 40-60.

Preferably, a number average molecular weight (Mₙ) of the group -[AO]ₙ—R^{a} is 500-5′000 g/mol, especially 1′000-4000 g/mol, in particular 1′500-3′500 g/mol, particularly 2′000-3′000 g/mol, especially preferred 2′100-2′700 g/mol.

Such a number of [AO] units in the group of the formula -[AO]ₙ—R^{a} and/or such number average molecular weights (Mₙ) of the group of the formula -[AO]ₙ—R^{a} have turned out to be a preferred choice with regard to the overall plasticizing effect of the copolymer in different mineral binder compositions.

In the present context, the weight-average molecular weight (M_{w}) and the number-average molecular weight (Mₙ) are determined presently by gel permeation chromatography (GPC) using polyethylene glycol (PEG) as a standard. This technique is known per se to the person skilled in the art.

According to another preferred embodiment, the ratio of the mole fractions a/b is 1.7-3.2, in particular 2.4-2.6.

With regards to the molar fractions, preferably, a=0.6-0.8 and b=0.2-0.4 and c=0-0.02, especially c=0.

In particular, a molar ratio of carboxylic acid groups to structural units S2 is 3-8, especially 3.4-6.4, preferably 4.8-5.2.

Regarding the weight of the copolymer, the copolymer preferably has a mean molecular weight Mₙ of 500-200′000 g/mol, especially 5′000-70′000 g/mol, in particular 15′000-50′000 g/mol.

With such kind of copolymer parameters, the plasticizing effects of the copolymers in mineral binder compositions can greatly be enhanced and maintained over relatively long time periods in different mineral binder systems. Nevertheless, copolymers with other parameters can be advantageous for specific applications or in combination with special mineral binder compositions.

In a particular embodiment, the copolymer comprises a further structural subunit S3. Thereby, the further structural units typically concerns units arising by polymerization of ethylenically unsaturated compounds, in particular ethylenically unsaturated carboxylic acids or derivatives thereof, particularly salts, anhydrides, esters, or amides thereof. With further structural subunit S3, the properties of the copolymer can e.g. be adapted to special applications.

Typically, if present, the further structural subunit S3 can e.g. be present with a proportion of >0-80 mole %, especially >0-60 mole %, in particular >0-50 mole %, especially >0-30 mole % or >0-20 mole %, with respect to the sum of the structural units S1, S2 and S3 of the copolymer.

Especially, if present, the further structural subunit S3 has a proportion of <50 mole % with respect to the sum of the structural units S1, S2 and S3 of the copolymer.

Particularly, If present, the structural subunit S3 can have a proportion of >0 to 10 mole %, especially, 0.0001-5 mole %, in particular 0.001-2 mole %, with respect to the sum of the structural units S1, S2 and S3 of the copolymer.

Examples of further structural subunit S3 are units arising by polymerization of acrylic acid, methacrylic acid, mesaconic acid, citraconic acid, glutaconic acid, fumaric acid, maleamic acid, itaconic acid, vinylbenzoic acid, crotonic acid, or anhydrides of the aforementioned acids or derivatives thereof, particularly the salts, anhydrides, esters, or amides thereof. Preferred are monocarboxylic acids, or derivatives thereof, particularly salts, anhydrides, esters, or amides thereof.

For example the further structural subunit S3 comprises or consists of acrylic acid and/or methacrylic acid.

Nevertheless, in a highly preferred embodiment, the copolymer has less than 2 mol % of structural subunit S3, especially less than 1 mol % structural subunit S3, particularly no structural subunit S3. Such kind of copolymers can be produced in a highly efficient and economic manner and at the same time show very good plasticizing effects in in various and different mineral binder systems.

Particularly preferred copolymers fulfill one or more, in particular all, of the following conditions in combination:
a) R¹═R⁴=—COOM and/or wherein R¹ and R⁴ together form an anhydride group —(CO)—O—(CO)—;
b) R²═R³═H;
c) R⁵=methyl group;
d) R⁶═R⁷═H;
e) n is 10-120, especially 22-80, preferably 30-70, especially preferred 40-60;
f) the ratio of the mole fractions a/b is 1.7-3.2, in particular 2.4-2.6;
g) a=0.6-0.8 and b=0.2-0.4 and c=0-0.02, especially c=0;
h) a molar ratio of carboxylic groups to structural units S2 is 3-8, especially 3.4-6.4, preferably 4.8-5.2;
i) the copolymer has a mean molecular weight Mₙ of 5′000-70′000 g/mol, in particular 15′000-50′000 g/mol.

Preferably, the copolymer is produced by free radical polymerization. Thereby the copolymer forms by the successive addition of free-radical building blocks. Thereby, the free-radical building blocks may be added in alternating, block-like or random manner.

In particular, the copolymer is produced in a polymerization reaction at a temperature of 10° C. to 50° C., preferably of 15° C. to 35° C. Surprisingly, such kind of copolymers can have a highly uniform distribution of structural subunits S1, S2 and if present S3.

In particular, the copolymer is obtained by a polymerization reaction which takes place in the presence of an initiator for free radical polymerization. The initiator preferably is a redox system-based initiator.

Especially, the initiator comprises a peroxide and a reducing agent. The reducing agent especially comprises a sulfinic acid derivate and/or a metal salt. In particular, the reducing agent comprises hydroxymethylsulfinate salt and/or an iron salt, preferably a sodium hydroxymethylsulfinate and an iron(II) salt, e.g. iron sulfate. The peroxide is in particular hydrogen peroxide.

According to a further preferred embodiment, the copolymer is obtained in a polymerization reaction which takes place in the presence of chain transfer agent. The chain transfer agent is in particular selected from the group comprising sulfonic acid, sulfonic acid derivatives and phosphites.

Preferably, the chain transfer agent is selected from sulfur compounds with sulfur in oxidation state +V and/or from phosphorous compounds with phosphor in oxidation state +IV. Sulfur compounds with sulfur in oxidation state +V are most preferred.

In particularly preferred, the chain transfer agent is selected from alkyl sulfonates and hypophosphites, especially the chain transfer agent is an unsaturated alkyl sulfonate, preferably methallylsulfonate.

Copolymers produced by using an initiator for free radical polymerization in combination with a chain transfer agent and at temperatures as mentioned above, turned out to have a surprisingly good performance when compared with copolymers produced with different initiators or chain transfer agents such as e.g peroxydisulfates and/or persulfates.

Thus, according to a particular preferred embodiment, the copolymer is obtained in a polymerization reaction which takes place in absence of peroxydisulfates and/or persulfates.

In a special embodiment, the copolymer comprises a chain transfer agent residue which is chemically bonded within the copolymer. Preferably the chain transfer agent residue is a residue of a sulfur and/or a phosphorous based chain transfer agent, in particular a residue of sulfonic acid, a sulfonic acid derivative and/or of a phosphite. Especially, the chain transfer agent residue comprises sulfur in oxidation state +V and/or phosphor in oxidation state +IV.

A further aspect of the present invention is related to a method for producing a copolymer, in particular a copolymer as described above, comprising the step of polymerizing:

a) a′ mole fractions of a compound S1′ of the formula (III):

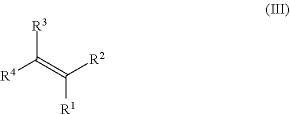

b) with b′ molar fractions of a compound S2′ of the formula (IV):

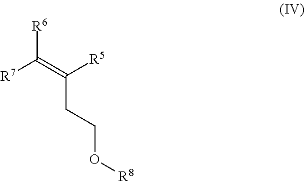

c) optionally c′ molar fractions of a further compound S3′;
wherein R¹, R², R³, R⁴, R⁵, R⁶, R⁷ and R⁸, are defined as described above in connection with the copolymer and where a′, b′, and c′ are mole fractions of the respective structural subunits S1′, S2′, an S3′, where
a′/b′/c′=(0.1-0.9)/(0.1-0.9)/(0-0.8), more particularly
a′/b′/c′=(0.4-0.85)/(0.15-0.5)/(0-0.6), preferably
a′/b′/c′=(0.6-0.8)/(0.2-0.4)/(0-0.01), and
with the proviso that a′+b′+c′ is 1 and
where a ratio of the mole fractions a′/b′ is 1.5-4.

Preferably, the copolymer is produced by free radical polymerization. Thereby the copolymer forms by the successive addition of free-radical building blocks. Thereby, the free-radical building blocks may be added in alternating, block-like or random manner.

In particular, the polymerization takes place at a temperature 10° C. to 50° C., preferably of 15° C. to 35° C. Surprisingly, under such conditions, compounds S1′, S2′ and if present S3′ can uniformly be incorporated into the copolymer. This is even the case, when the molar proportions of the individual compounds are adapted.

In particular, the polymerization takes place in the presence of an initiator for free radical polymerization. The initiator preferably is a redox system-based initiator.

Especially, the initiator comprises a peroxide and a reducing agent. The reducing agent especially comprises a sulfinic acid derivate and/or a metal salt. In particular, the reducing agent comprises hydroxymethylsulfinate salt and/or an iron salt, preferably a sodium hydroxymethylsulfinate and an iron(II) salt, e.g. iron sulfate. The peroxide is in particular hydrogen peroxide.

According to a further preferred embodiment, the polymerization takes place in the presence of chain transfer agent. The chain transfer agent is in particular selected from the group comprising sulfonic acid, sulfonic acid derivatives and phosphites.

Preferably, the chain transfer agent is selected from sulfur compounds with sulfur in oxidation state +V and/or from phosphorous compounds with phosphor in oxidation state +IV. Sulfur compounds with sulfur in oxidation state +V are most preferred.

In particularly preferred, the chain transfer agent is selected from alkyl sulfonates and hypophosphites, especially the chain transfer agent is an unsaturated alkyl sulfonate, preferably methallylsulfonate.

Preferably, the chain transfer agent is used in a proportion of 1-5 wt.-%, especially 2-3 wt.-%, with respect to the total weight of the compounds S1′, S2′, and S3′ or the structural units S1, S2 and S3, respectively.

Using an initiator for free radical polymerization in combination with a chain transfer agent as mentioned above turned out to be surprisingly efficient in the polymerization of compounds S1′ and S2′. In particular, it is possible to produce copolymers with surprisingly good performance when compared with copolymers produced with different initiators or chain transfer agents such as e.g peroxydisulfates and/or persulfates. Moreover, since only moderate or no heating is required, the method is highly economical as well.

Thus, according to a particular preferred method, the polymerization takes place in absence of peroxydisulfates and/or persulfates.

Another aspect of the present invention is related to a hydraulically setting binder composition comprising a copolymer as described above and a hydraulically setting binder, in particular cement and/or gypsum.

The mineral binder composition comprises at least one mineral binder. The expression “mineral binder” refers more particularly to a binder which reacts in the presence of water, in a hydration reaction, to give solid hydrates or hydrate phases. This may be, for example, a hydraulic binder (e.g., cement or hydraulic lime), a latent hydraulic binder (e.g., slag), a pozzolanic binder (e.g., flyash), or a nonhydraulic binder (gypsum or white lime).

The mineral binder or the binder composition comprises more particularly a hydraulic binder, preferably cement. Particularly preferred is a cement with a cement clinker fraction of ≥35 wt %. In particular the cement is of type CEM I, CEM II and/or CEM III, CEM IV or CEM V (according to standard EN 197-1). A fraction of the hydraulic binder as a proportion of the overall mineral binder is advantageously at least 5 wt %, more particularly at least 20 wt %, preferably at least 35 wt %, especially at least 65 wt %. According to a further advantageous embodiment, the mineral binder consists to an extent of ≥95 wt % of hydraulic binder, more particularly of cement clinker.

It may, however, also be advantageous if the mineral binder or the mineral binder composition comprises or consists of other binders. These are, in particular, latent hydraulic binders and/or pozzolanic binders. Examples of suitable latent hydraulic and/or pozzolanic binders include slag, flyash and/or silica dust. The binder composition may also comprise inert materials such as, for example, limestone, finely ground quartzes and/or pigments. In one advantageous embodiment the mineral binder contains 5-95 wt %, more particularly 5-65 wt %, more preferably 15-35 wt % of latent hydraulic and/or pozzolanic binders. Advantageous latent hydraulic and/or pozzolanic binders are slag and/or flyash.

In one particularly preferred embodiment the mineral binder comprises a hydraulic binder, more particularly cement or cement clinker, and a latent hydraulic and/or pozzolanic binder, preferably slag and/or flyash. The fraction of the latent hydraulic and/or pozzolanic binder in this case is more preferably 5-65 wt %, more preferably 15-35 wt %, while there is at least 35 wt %, especially at least 65 wt %, of the hydraulic binder.

According to a further preferred embodiment, the mineral binder comprises or consists of gypsum. According to the invention, the term “gypsum” stands for in any known modification of gypsum or mixtures thereof. The gypsum is, in particular, chosen form calcium sulfate dihydrate, calcium sulfate-α-hemihydrate, calcium sulfate-p-hemihydrate, or calcium sulfate anhydride and mixtures thereof.

In a highly preferred embodiment, the gypsum is calcium sulfate-β-hemihydrate. Gypsum compositions based on calcium sulfate-β-hemihydrate are preferably used for the manufacture of drywall. Preferably, the gypsum composition includes at least 70 wt % of calcium sulfate-β-hemihydrate; even more preferred is at least 90 wt % of calcium sulfate-β-hemihydrate, relative to the total weight of the binder.

In another preferred embodiment, the binder composition additionally contains solid aggregates, especially gravel, sand and/or aggregates. Corresponding compositions can be used, for example, as mortar mixtures or concrete mixtures.

In addition, common components such as other concrete plasticizers, for example lignosulfonates, sulfonated naphthalene-formaldehyde condensates, sulfonated melamine-formaldehyde condensates, or polycarboxylate ethers, accelerators, corrosion inhibitors, retardants, shrinkage reducing agents, antifoaming agents, or pore formers may be present in the mineral binder composition.

In the present context, a mineral binder composition is more particularly a processable and/or aqueous mineral binder composition.

The mineral binder composition is preferably a mortar composition, a concrete composition or a gypsum composition. The mineral binder composition is more particularly a mineral binder composition which is processable and/or is mixed with water.

A weight ratio of water to binder in the mineral binder composition is preferably in the range of 0.25-0.7, more particularly 0.26-0.65, preferably 0.27-0.60, especially 0.28-0.55.

The copolymer is used advantageously with a fraction of 0.01-10 wt %, more particularly 0.1-7 wt % or 0.2-5 wt %, based on the binder content.

Another aspect of the present invention is related to a molding obtainable by curing a binder composition as described above after addition of water. These moldings may in principle be shaped in any way and may be part of a construction, for example, a building, a traffic way or a bridge.

Furthermore, the present invention is concerned with the use of a copolymer as described above as a dispersant for hydraulically setting binder compositions, in particular in cement and/or gypsum compositions. In particular, the copolymer is used for improving the processability of hydraulically setting compositions and/or for extending the time of processability of hydraulically setting compositions.

Further advantageous embodiments and combinations of features of the invention will emerge from the following exemplary embodiments and the totality of the patent claims.

### Exemplary Embodiments

### 1. Preparation of Copolymers

### 1.1 Copolymer E1

235 g water, 7.06 g methallyl sulfonic acid sodium salt and 346 g of an unsaturated polyalkylene glycol ether TPEG-2400 (formed by adding on average 55 mol of ethylene oxide (EO) to 3-methyl-3-buten-1-ol) have been placed in a reaction vessel. Then a mixture of 117.70 g water and 35.30 g maleic acid anhydride and subsequently 1.5 g of an iron(II) sulfate solution (10% in water) were added to the reaction vessel.

Following this step, a first premixture (14.10 water, 4.71 g H₂O₂ (35%)) and a second premixture (23.5 g water and 2.12 g Rongalit C) were dropped into the reaction vessel at a temperature of 20° C. to 35° C. and over a period of 60 min or 65 min, respectively, under agitation. Agitation continued until a peroxide test was negative.

After the end polymerization reaction, a clear, viscous solution of copolymer E1 was obtained which was adjusted to a pH of around 4.

### 1.2 Further Copolymers

Further copolymers have been produced similarly as copolymer E1 as described in the following table 1:

TABLE 1
Copolymers

| | | | | | Molar ratio |
|---|---|---|---|---|---|
| | Acid | Side Chain | | Chain transfer | acid/side |
| No. | (S1′)¹⁾ | (S2′)²⁾ | Initiator³⁾ | agent⁴⁾ | chains |
| E1 | MAA | TPEG-2400 | R | Methallyl sulfonate | 2.45 |
| E03* | AA | TPEG-2400 | R | Methallyl sulfonate | 4.89 |
| E04 | MAA | TPEG-1000 | R | Methallyl sulfonate | 2.45 |
| E05 | MAA | TPEG-1000 | S | None | 1.10 |
| E06 | MAA | TPEG-1000 | T | None | 1.10 |
| E07 | MAA | TPEG-2400 | R | Methallyl sulfonate | 1.72 |
| E08 | MAA | TPEG-2400 | R | Methallyl sulfonate | 2.98 |
| E09⁴⁾ | MAA | TPEG-2400 | R | Methallyl sulfonate | 2.45 |
| E10⁵⁾ | MA | TPEG-2400 | T | Mercapto propionic | 2.65 |
| | | | | acid | |
| E11 | MA | TPEG-2400 | R | Mercapto propionic | 2.65 |
| | | | | acid | |
| E75 | MAA | TPEG-2400 | R | Hypophosphite | 2.45 |
| E86* | AA | TPEG-2400 | R | Methallyl sulfonate | 2.45 |
| E88* | AA | TPEG-2400 | R | Hypophosphite | 2.45 |

¹⁾MAA = Maleic acid anhydride; AA = Acrylic acid; MA = Maleic acid
²⁾TPEG-2400: formed by adding on average 55 mol of ethylene oxide (EO) to 3-methyl-3-buten-1-ol; TPEG-1000: formed by adding on average 23 mol of ethylene oxide (EO) to 3-methyl-3-buten-1-ol
³⁾R = H₂O₂/Rongalit C/ Fe(II); S = Sodium persulfate; T = Ammonium persulfate
⁴⁾Polymerization temperature = 60° C.
⁵⁾Polymerization temperature = 80° C.
*= Comparative example

### 2. Mortar Tests

The copolymers were tested in mortar mixtures. For this, mortars with solid components as specified in table 2 were used.

TABLE 2
Mortar mixtures

| Component | Quantity |
|---|---|
| Cement (Swiss CEM I 42.5) | 750 g |
| Limestone filler | 141 g |
| Sand 0-1 mm | 738 g |
| Sand 1-4 mm | 1107 g |

Sand, filler, and cement were mixed dry for 1 minute in a Hobart mixer. The mixing water, in which 1.1% of 20% solution of copolymer of the invention or a comparative copolymer was dissolved, was added within 30 seconds and mixing was continued for another 2.5 minutes. The total wet mixing time was 3 minutes. The water/cement value (w/c value) was 0.41.

Then, the flow table spread (FTS) of the mortar was determined according to EN 1015-3 at 0 minutes (directly after mixing), 30 minutes, 60 minutes and 90 minutes after mixing. Table 3 gives an overview of the results obtained:

TABLE 3
Results mortar mixtures

| | | FTS [mm] | | | |
|---|---|---|---|---|---|
| Exp. | Copolymer | 0 Min. | 30 Min. | 60 Min. | 90 Min |
| M1 | E1 | 194 | 222 | 186 | 159 |
| M2 | E03 | 113 | 107 | n.a. | n.a |
| M3 | E04 | 167 | 144 | 133 | 123 |
| M4 | E05 | 136 | 123 | 114 | n.a. |
| M5 | E06 | 137 | 122 | 112 | n.a. |
| M6 | E07 | 185 | 219 | 196 | 161 |
| M7 | E08 | 190 | 185 | 161 | 145 |
| M8 | E09 | 163 | 150 | 141 | 130 |
| M9 | E10 | 188 | 138 | 133 | 123 |
| M10 | E75 | 163 | 180 | 178 | 146 |
| M11 | E86 | 166 | 146 | 131 | 121 |
| M12 | E88 | 168 | 152 | 129 | 120 |

As evident from table 3, the FTS of mortar mixtures M2, M11, and M12 with non-inventive copolymers E03, E86 and E88 are clearly lower than the FTS of comparable mortar compositions which comprise inventive copolymers.

### 3. Gypsum Tests

First, 116 g of water were mixed with the copolymer. Then 200 g of calcium sulfate-β-hemihydrate and 0.2 g of calcium sulfate dihydrate (accelerator) were sprinkled within 15 seconds into the water and the gypsum slurry was allowed to drain for 15 seconds. The slurry was then stirred intensively for 30 seconds by hand.

The flow table spread (FTS), the beginning of stiffening (VB), and the end of stiffening (VE) of gypsum slurries were determined as follows:

A minicone with a diameter of 50 mm and a height of 51 mm was filled with the freshly produced gypsum slurry and after 75 seconds, the minicone was lifted. The diameter of the gypsum cake thus formed was measured, until flow was no longer observed. The diameter of the cake in mm was designated as the slump. The beginning of stiffening (VB) and the end of stiffening (VE) were determined by the knife-cut method according to DIN EN 13279-2 and the thumb-pressure method. The beginning of stiffening (VB) is reached when, after a knife cut through the gypsum cake, the cut edges no longer run together. The end of stiffening (VE) occurs when, with a finger pressure of about 5 kg, water no longer comes out of the gypsum cake. The following table 4 gives an overview of the results obtained.

TABLE 4
Results gypsum slurries

| Exp. | Copolymer | FTS [mm] | VB [min:sec] | VE [min:sec] |
|---|---|---|---|---|
| G1 | E01 | 199 | 3:40 | 10:20 |
| G2 | E03 | 140 | 4:15 | 13:10 |
| G3 | E04 | 193 | 5:50 | 12:50 |
| G4 | E05 | 170 | 03:00 | 09:05 |
| G5 | E06 | 164 | 03:05 | 09:20 |
| G6 | E07 | 196 | 03:20 | 09:45 |
| G7 | E08 | 202 | 04:45 | 10:55 |
| G8 | E09 | 186 | 04:05 | 10:10 |
| G9 | E10 | 160 | 03:50 | 10:30 |
| G10 | E75 | 207 | 04:25 | 10:40 |

As evident from table 4, the FTS of gypsum slurry G2 with non-inventive copolymer E03 is clearly lower than the FTS of comparable mortar compositions which comprise inventive copolymers.

Thus, the data shown above clearly shows that copolymers according to the present invention are highly effective plasticizers or fluidizers, respectively, in cementitious as well as in gypsum based systems which additionally allow for prolonging the processing time of such systems. At the same time the inventive copolymers can be produced in an efficient and economic manner.

It will be appreciated by those skilled in the art that the present invention can be embodied in other specific forms without departing from the spirit or essential characteristics thereof. The presently disclosed embodiments are therefore considered in all respects to be illustrative and not restricting.

1. A copolymer comprising:
a) a mole fractions of a structural subunit S1 of the formula (I) 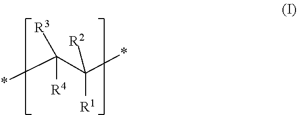
b) mole fractions of a structural subunit S2 of the formula (II) 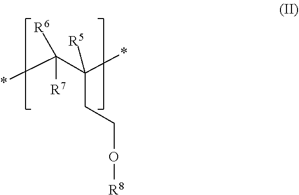
c) optionally, c mole fractions of a further structural subunit S3;
where
R¹ and R⁴, in each case independently of any other, is —COOM, —(CH₂)—COOM, COOR⁸ or R¹ and R⁴ together form an anhydride group —(CO)—O—(CO)—;
R², R³, R⁶, and R⁷, in each case independently of one another, are H or an alkyl group with 1-5 carbon atoms;
R⁵, in each case independently of one another, is an alkyl group with 1-5 carbon atoms;
R⁸, in each case independently of one another, is a group of the formula -[AO]ₙ—R^{a}, where A is C₂ to C₄ alkylene; R^{a} is H, a C₁ to C₂₀ alkyl, cycloalkyl or alkylaryl group; and n is 2-250;
M, independently of any other, is H⁺, an alkali metal ion, an alkaline earth metal ion, a di- or trivalent metal ion, an ammonium ion or an organic ammonium group
and where a, b, and c are mole fractions of the respective structural subunits S1, S2, an S3,
where
a/b/c=(0.1-0.9)/(0.1-0.9)/(0-0.8),
and
with the proviso that a+b+c is 1;
and where a ratio of the mole fractions a/b is 1.5-4.

2. The copolymer according to claim 1, wherein R²═R³═H and wherein R¹═R⁴=—COOM and/or wherein R¹ and R⁴ together form an anhydride group —(CO)—O—(CO)—, and wherein R⁵ is a methyl group and R⁶═R⁷═H.

3. The copolymer according to claim 1, wherein A=C₂ alkylene and n is 10-120 and/or wherein a number average molecular weight (Mₙ) of the group -[AO]ₙ—R^{a} is 500-5,000 g/mol.

4. The copolymer according to claim 1, wherein the ratio of the mole fractions a/b is 1.7-3.2.

5. The copolymer according to claim 1, wherein a=0.6-0.8 and b=0.2-0.4 and c=0-0.02.

6. The copolymer according to claim 1, wherein the copolymer comprises a chain transfer agent residue which is chemically bonded within the copolymer and wherein the chain transfer agent residue comprises sulfur in oxidation state +V and/or phosphor in oxidation state +IV.

7. A method for producing a copolymer according to claim 1, comprising the step of polymerizing:
a) a′ mole fractions of a compound S1′ of the formula (III): 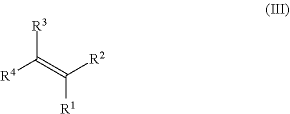
b) with b′ molar fractions of a compound S2′ of the formula (IV): 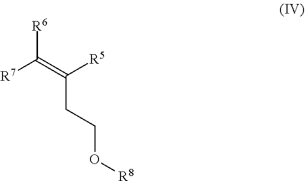
c) optionally c′ molar fractions of a further compound S3′;
wherein R¹, R², R³, R⁴, R⁵, R⁶, R⁷ and R⁸, are defined as in claim 1 and
where a′, b′, and c′ are mole fractions of the respective compounds S1′, S2′, an S3′, where
a′/b′/c′=(0.1-0.9)/(0.1-0.9)/(0-0.8),
and
with the proviso that a′+b′+c′ is 1;
and where a ratio of the mole fractions a′/b′ is 1.5-4.

8. The method according to claim 7 whereby the copolymer is produced by free radical polymerization at a temperature 10° C. to 50° C.

9. The method according to claim 7 whereby the polymerization takes place in the presence of an initiator for free radical polymerization.

10. The method according to claim 9, whereby the initiator for free radical polymerization comprises a combination of a peroxide and a reducing agent, whereby the reducing agent comprises a sulfinic acid derivate and/or a metal salt.

11. The method according to claim 7 whereby the polymerization takes place in the presence of chain transfer agent whereby the chain transfer agent is selected from the group of sulfonic acid, sulfonic acid derivatives and phosphites.

12. The method according to claim 11 whereby the chain transfer agent is selected from alkyl sulfonates and hypophosphites.

13. A method of using a copolymer according to claim 1 comprising using the copolymer as a dispersant for hydraulically setting binder compositions.

14. A hydraulically setting binder composition comprising a copolymer according to claim 1 and a hydraulically setting binder.

15. A molding obtainable by curing a binder composition as claimed in claim 14 after addition of water.
